(19) United States
(12) Patent Application Publication
(10) Pub. No.: US 2010/0292894 A1
(43) Pub. Date: Nov. 18, 2010

(54) METHOD AND APPARATUS FOR CONTROLLING AN ACTIVE VEHICLE SUBSYSTEM

(75) Inventors: Ali El Essaili, Mainz (DE); Youssef Ghoneim, Oakland, CA (US)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/773,636

(22) Filed: May 4, 2010

(30) Foreign Application Priority Data
May 12, 2009 (GB) 0908115.9

(51) Int. Cl. G06F 19/00

(52) U.S. Cl. 701/37; 701/36; 701/41

(57) ABSTRACT

A method is provided for controlling at least one active subsystem in a motor vehicle. The method includes, but is not limited to the steps of repeatedly collecting vehicle motion data (aᵢ, vᵢ, i=1, . . . ), selecting a setting for at least one operating parameter of the active subsystem based on the collected vehicle motion data, judging, based on said collected vehicle motion data, whether the vehicle is in an urban environment or not. When selecting said setting, vehicle motion data (aᵢ, vᵢ, i=1, . . . ) collected while the vehicle is judged to be in an urban environment are disregarded.

### CROSS-REFERENCE TO RELATED APPLICATION

This application claims priority to British Patent Application No. 0908115.9, filed May 12, 2009, which is incorporated herein by reference in its entirety.

### TECHNICAL FIELD

The present invention relates to a method for automatically controlling the operation of an active subsystem in a vehicle chassis, in particular for controlling a suspension system.

### BACKGROUND

Methods and apparatus for adaptively controlling the stiffness of a vehicle suspension are known from various documents. Mostly, these methods are concerned with the adaptive control of vehicle suspension in response to instantaneous values of motion parameters of the vehicle. For instance, JP 58 056 907 A discloses a damping force adjustor for a vehicle suspension in which the suspension is set to different degrees of rigidity depending on whether the vehicle speed is above or below fifty km/h. WO 2006/126 342 A1 relates to a vehicle damping force control apparatus which is adapted to calculate a target pitch angle for a vehicle under given motion conditions and to control the rigidity of shock absorbers so that the target pitch angle is achieved.

A very different type of adaptive suspension control system and method is known from WO 2007/107 363 A1. This document suggests to judge the driving style of a driver of the vehicle based on collected vehicle motion data and to select the setting for the suspension stiffness based on the judgment of the driving style. Generally speaking, if strong accelerations are frequent, the driving style is judged to be sporty, and the suspension is set to be more rigid than if the driver exhibits a sedate driving style with infrequent strong accelerations. While the systems of the two first mentioned documents determine the suspension settings based on the current state of motion of the vehicle and will therefore always select the same suspension if a same path is driven twice at the same speed, the system of WO 2007/107 363 A1 my adopt different settings, depending on what it has determined to be the driver's style. By using a generally rigid setting of the suspension for a sporty driver, the driver can be conveyed a very direct “feel” for the road, whereas for a sedate driver a softer, more comfortable setting can be chosen. Thus, based on the concepts of WO 2007/107 363 A1 it is possible to design a vehicle which is capable of suiting the tastes of very differently natured drivers.

A problem of this control method and apparatus is that traffic situations are frequent in which a driver cannot drive according to his taste but traffic conditions require a more or less standardized behavior of all drivers. This is particularly true for urban traffic, where stops at traffic lights, speed limits, stop-and-go traffic etc. leave little room for a driver's individuality. Therefore, after some time spent in urban traffic, the system of WO 2007/107 363 A1 is likely to judge all drivers to have the same style. In the time the system needs to readapt to the driver's individual style after leaving town, the suspension setting is likely not to be ideally adapted.

This problem is not limited to adaptive suspensions but is common to all types of active vehicle subsystems which are capable of adapting to a driver's driving style.

### SUMMARY

In view of the foregoing, it is at least one object of the present invention is to overcome this deficiency. In addition, other objects, desirable features, and characteristics will become apparent from the subsequent summary and detailed description, and the appended claims, taken in conjunction with the accompanying drawings and this background.

In accordance with an embodiment of the invention a method is provided for controlling at least one active subsystem, in particular a suspension system, in a motor vehicle, the method comprising the steps of repeatedly collecting vehicle motion data, selecting a setting for at least one operating parameter of the active subsystem based on the collected vehicle motion data. The method also comprises the steps of judging, based on said collected vehicle motion data, whether the vehicle is in an urban environment or not, and when selecting said setting, disregarding vehicle motion data collected while the vehicle is judged to be in an urban environment.

For selecting the setting, a scalar driving style descriptor may be calculated based on the collected vehicle motion data, and a setting associated to the current value of the driving state descriptor is selected from a plurality of predetermined settings.

Preferably, the calculation of the driving style descriptor comprises calculating a present value of the descriptor as a predetermined function of presently collected vehicle motion data and a previously calculated value of the driving style descriptor. Then, in step d) calculation of the present value of the scalar driving style descriptor may simply be suspended while the vehicle is judged to be in an urban environment.

For setting selection, the current value of the driving state descriptor may simply be compared to a predetermined threshold, and a first or a second setting is selected depending on whether the current value is above or below said threshold. The vehicle may be judged to be in an urban environment if at least the vehicle speed is detected to be below a predetermined first speed threshold. Additional conditions for deciding that the vehicle is in an urban environment may be defined, if appropriate.

Preferably, said first speed threshold is considerably below speed limits set by law for intra-urban traffic, since there may be good reasons for driving at a moderately low speed out of town too, e.g. bad road conditions, and the method should be capable of adapting to such a situation, too, by choosing a rather soft setting of suspension.

An appropriate value for said first speed threshold is between approximately 2 and 10 m/s, preferably about 5 m/s.

For reversing the decision that the vehicle is in an urban environment, or for deciding that the vehicle is not in an urban environment, various suitable conditions can be defined, for example, if the vehicle speed is detected to be above a predetermined second speed threshold which is higher than the above mentioned first speed threshold, or if the vehicle speed is detected to be above said first speed threshold, and the time since the vehicle speed was last detected to be below said first speed threshold is longer than a predetermined time threshold.

The second speed threshold is preferably at least twice the first speed threshold, preferably it is in a range of about 15 m/s. The time threshold may be set between about 30 and 120 seconds, preferably about 60 seconds.

Assuming that there is a value or a range of values of the driving style descriptor which cannot be reached when driving in the speed range allowed for urban driving, it is practical to decide that the vehicle is not in an urban environment, even if the speed condition is fulfilled, if the driving state descriptor is above a predetermined descriptor threshold.

The invention is applicable to a wide variety of active subsystems in a vehicle. Preferably, the active system is a suspension system and the operating parameter is its stiffness, or the active system is a power steering system, and the operating parameter is a degree of assistance provided to the driver, or the ratio between steering wheel and road angles, or the active system is an engine controller and the operating parameter is the variation of the engine load with the accelerator pedal position, or the active system is a transmission controller and the operating parameter is an algorithm used for selecting gear ratios, or the active system is a brake controller, and the operating parameter is the ratio of brake displacement to brake pedal displacement or the amount of slippage permitted before an anti-blocking system or an ESP system of the brake controller is activated.

### BRIEF DESCRIPTION OF THE DRAWINGS

The present invention will hereinafter be described in conjunction with the following drawing figures, wherein like numerals denote like elements, and

FIG. 1 is a block diagram of a motor vehicle equipped with an adaptive suspension control according to an embodiment of the invention; and

FIG. 2 is a flow chart of a control process carried out by the master controller of the vehicle of FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

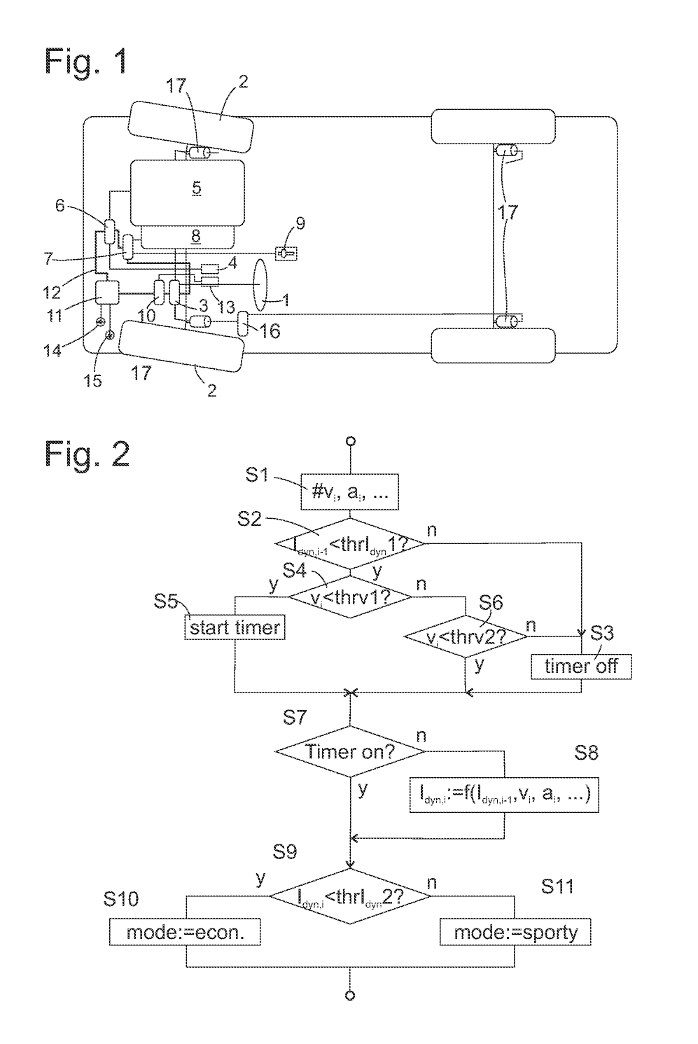

FIG. 1 is a schematic diagram of a motor vehicle illustrating in block form some components which are relevant to the embodiment of the present invention and some subsystems to which the invention is applicable. It should be understood that these components are not necessarily essential, and may be applicable to other subsystems than those shown, too.

A steering wheel 1 controls the steering angle of front wheels 2 of the motor vehicle by means of a power steering controller 3. The power steering controller 3 has actors for turning the front wheels 2 in proportion to the angular position of steering wheel 1, and actors for exercising on the steering wheel 1 a counter-torque to a torque imposed by the driver. The power steering controller 3 supports a plurality of operating states which differ from each other by the degree of assistance provided to the driver, i.e., by the proportion between the torque applied by the actors to the front wheels and the counter-torque experienced by the driver. The power steering controller 3 further has a so-called Active Front Steering functionality, i.e., it supports a number of states having different ratios between the angle by which the driver turns steering wheel 1 and the corresponding yaw angle of the front wheels 2.

An accelerator pedal 4 controls the load of an engine 5 via an electronic engine controller 6. Engine controller 6 supports a plurality of states which use different characteristics for controlling the motor load as a function of the accelerator pedal position. For example, there may be a “sedate” state in which the load varies little with the pedal position, and there may be a “dynamic” state in which the load varies strongly with the pedal position.

A transmission controller 7 controls a gearbox 8 based primarily on engine load and speed detected by sensors, not shown, at engine 5. A gearshift lever 9 is connected to the transmission controller 7, so as to enable the driver to choose between different states of the transmission controller 7, which use different algorithms for selecting the gear ratio in gearbox 8 based on engine speed and load, or for overriding a gear ratio selected by transmission controller 7.

Electronic brake controller 10 controls the reaction of brakes, not shown, provided at the vehicle wheels, to the driver pressing a brake pedal 13. The brake controller 10 may implement conventional brake control schemes such as an anti-blocking system or an electronic stability program ESP, and different states of the brake controller 10 may vary in the amount of wheel slippage permitted before the anti-blocking system or the ESP is activated.

A suspension controller 16 is provided for controlling the stiffness of the vehicle's wheel suspension, different states of the suspension controller 14 corresponding to different degrees of rigidity it imposes upon shock absorbers 17 of front and rear wheels 2.

All these controllers 3, 6, 7, 10 are connected as sub-controllers or slave controllers to a master controller 11. Acceleration sensors 14, 15 for sensing longitudinal and transversal vehicle acceleration and various other sensors, not shown, are associated to master controller 11. A bus system 12 ensures communication among the controllers 3, 6, 7, 10, 11, 16 and between the controllers 3, 6, 7, 10, 11, 16 and their associated sensors.

The task of the master controller 11 is to decide which one of the various states supported by the sub-controllers 3, 6, 7, 10, 16 a given sub-controller is actually to assume. The master controller 11 can be designed to support various operating modes. There can, for example, be a mode in which it decides the sub-controller states based on data which the driver can input directly, e.g., by actuating switches. A switch may be associated directly to a sub-controller, the position of the switch specifying in a one-to-one relationship the state to be assumed by the sub-controller. Alternatively, positions of the switches can be associated to external parameters that are relevant for the choice of sub-controller states, such as road conditions (dry/wet, solid/sandy/muddy), towing/non-towing mode, 2-wheel drive/4-wheel drive, etc. Further there is a mode in which the master controller decides the states of the sub-controllers based on the driver's behavior (and, eventually, switch positions set by the driver). Judging the driver's behavior involves calculation by the master controller 11 of a driving style descriptor. An example of such a driving style descriptor is the dynamic index Idyn as described in WO 2007/107 363 A1, which is incorporated herein in its entirety by reference. It will be readily apparent to the man of the art, however, that the present invention is not limited to a specific type of driving style descriptor but can be carried out based on any scalar quantity the value of which is representative of driving style.

The method shown in the flow chart of FIG. 2 is executed regularly, at times t₁ . . . , tⁱ⁻¹, t₁, tᵢ₊₁, . . . . In the i-th iteration of the method, at time tᵢ, master controller 11 fetches current vehicle motion data, e.g., vehicle speed vᵢ, acceleration aᵢ etc. from the vehicle's speedometer, from acceleration sensors 14, 15, etc. The data collected in step S1 are those which will later be needed for evaluating the driving style descriptor, so the quantities collected may vary from one embodiment of the method to another, depending on the type of driving style descriptor used.

In step S2, the driving style descriptor I_{dyn, i-1} calculated in the previous iteration of the method is compared to a descriptor threshold thrI_{dyn1}. The threshold thrI_{dyn1} is set so high that reaching it while driving in an urban environment and respecting traffic regulation can be regarded as impossible or, at least highly improbable. So, if the threshold thrI_{dyn1} is exceeded, the vehicle can safely be assumed to be moving in an extra-urban environment, and the method proceeds to steps S3, to be discussed in detail later in this document. On the other hand, if the threshold thrI_{dyn1} is not reached, the master controller 11 compares the current vehicle speed vᵢ with a first speed threshold in step S4. This first speed threshold thrv1 is set rather low, somewhat higher than walking speed, but at a small fraction of the admissible maximum speed for urban driving. For instance, the first speed threshold may be 5 m/sec. If vᵢ is below said threshold thrv1 (including the case that vᵢ is zero or negative, i.e., the vehicle is stopped or in reverse gear), a timer is started in step S5. When started, the timer will stay active for a predetermined time, e.g., 60 seconds, unless it is restarted, in which case the predetermined period of 60 seconds starts anew, or the timer is switched off, under conditions still to be described. The active time of the timer is longer than the iteration period of the process shown in FIG. 2, i.e., when the process begins, the timer may be inactive, or it may still be active from a previous iteration of the process. The active state of the timer can be regarded as a flag indicating that the vehicle is moving in urban traffic.

If the vehicle speed vᵢ is above the first threshold thrv1, the method proceeds to step S6, in which vᵢ is compared to a second, higher speed threshold thrv2. This second threshold is approximately the statutory speed limit for urban traffic in a country where the vehicle is operating. In Europe, a value thrv2=15 m/sec. is appropriate.

If the vehicle speed is above the second threshold thrv2, it is safe to assume that the vehicle is not in an urban environment, and the method branches to step S3, mentioned above, in which the timer is switched off.

If the speed vᵢ is below said second threshold thrv2, or after starting the timer in step 55, or after switching it off in step S3, the method proceeds to step S7 in which the status of the timer is verified. If the timer is off, i.e., if the vehicle can be assumed not to be moving in urban traffic, the driving style descriptor is updated in step S8 using a predetermined function f of the driving style descriptor I_{dyn, i-1} obtained in the i−1^{st} duration of the method, and the vehicle motion data vᵢ, aᵢ, . . . obtained at time tᵢ in step S1:

I_{dyn, i-1}=f(I_{dyn, I}, vᵢ, aᵢ, . . . ).

If the timer is on, indicating that the vehicle is involved in urban traffic, the step S8 of updating the driving style descriptor is skipped. So the value of the driving style descriptor is frozen as long as the vehicle is in urban traffic, and will be available again unchanged as soon as the vehicle is found to be moving outside town again.

In step S9, the current driving style descriptor I_{dyn, i}, which may have been updated in step S8 of this iteration or not, is compared to a second descriptor threshold thrI_{dyn2}, which is substantially lower than the threshold thrI_{dyn1} of step S2. Depending on the result of the comparison, the master controller 11 either adopts an economic mode in step S10 or a sporty mode in step S11. Controlling instructions subsequently sent to the various sub-controllers 6, 7, 10, 16 depend on this adopted mode. For example, the master controller 11 may instruct power steering controller 3 to use different transmission ratios between steering wheel angle and road angle in sporty and economic modes, in general so that for a given steering wheel angle the road angle is larger in the sporty mode than in the economic mode. The engine controller 6 is instructed to adopt the “sedate” state in the economic mode and the “dynamic” state in sporty mode. Transmission controller 7 may use different gear switch algorithms depending on the mode of the master controller, rotation speed thresholds for up shifting being generally higher in the sporty mode than in the economic mode.

In the suspension controller 16, according to a simple embodiment two different stiffness values for the shock absorbers 17 may be set depending on the mode adopted by the master controller 11. In a more sophisticated embodiment, the rigidity of the shock absorbers 17 may be variable depending on rapidly fluctuating parameters such as steering wheel angle, lateral acceleration, vehicle speed etc., the range in which the rigidity is allowed to vary being different in the economic and sporty modes. In either embodiment the rigidity will be higher in the sporty mode than in the economic mode.

Although the invention was described in detail here referring only to suspension control, it will be obvious to the skilled person that it is easily applicable to the any of the active subsystems referred to in the description of FIG. 1. Namely, if the active system is the power steering system, the operating parameter is a degree of assistance provided to the driver, or the ratio between steering wheel and road angles. If the active system is engine controller 6, the operating parameter is the variation of the engine load with the accelerator pedal position. If the active system is the transmission controller 7, the operating parameter specifies whether the transmission controller 7 uses a comfort-oriented or a power-oriented switching algorithm for selecting gear ratios. The active system might be the brake controller 10, in that case the operating parameter is the ratio between brake displacement and the displacement of brake pedal 13 or the amount of slippage permitted before the anti-blocking system or the ESP system of the brake controller 10 is activated.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for controlling at least one active subsystem in a motor vehicle, comprising the steps of:
repeatedly collecting vehicle motion data;
selecting a setting for at least one operating parameter of the at least one active subsystem based on the vehicle motion data;
judging based on the vehicle motion data whether or not the motor vehicle is in an urban environment; and
when selecting said setting, disregarding the vehicle motion data collected while the motor vehicle is judged to be in the urban environment.

2. The method of claim 1, wherein the step of selecting comprises the steps of:
calculating a scalar driving style descriptor on the vehicle motion data; and
selecting from a plurality of pre-determined settings, a setting associated to a current value of the scalar driving style descriptor.

3. The method of claim 2, wherein the step of calculating the scalar driving style descriptor comprises the step of calculating a present value of the scalar driving style descriptor as a pre-determined function of presently collected vehicle motion data and a previously calculated value of the scalar driving style descriptor, and
wherein the step of disregarding comprises the step of suspending calculation of the present value of the scalar driving style descriptor while the motor vehicle is judged to be in the urban environment.

4. The method of claim 2, wherein the step of selecting from the plurality of pre-determined settings comprises the steps of:
comparing the current value of the scalar driving style descriptor to a threshold; and
selecting a first pre-determined setting or a second pre-determined setting from the plurality of pre-determined settings depending on whether said current value exceeds said threshold.

5. The method of claim 1 wherein the step of judges comprises the step of deciding that the motor vehicle is in the urban environment if at least a vehicle speed is detected to be below a predetermined first speed threshold.

6. The method of claim 5, wherein said predetermined first speed threshold is between approximately 2 m/s and approximately 10 m/s.

7. The method of claim 5, wherein said predetermined first speed threshold is approximately 5 m/s.

8. The method of claim 1, wherein the step of judging comprises deciding that the motor vehicle is in not the urban environment if at least a vehicle speed is detected to be above a predetermined second threshold which is higher than a first threshold or the vehicle speed is detected to be above said first threshold, and a time since the vehicle speed was last detected to be below said first threshold is above a predetermined time threshold.

9. The method of claim 8, wherein the predetermined second threshold is at least twice a predetermined first speed threshold.

10. The method of claim 7, wherein the time is between approximately 30 s and approximately 120 s

11. The method of claim 7, wherein the time is approximately 60 s.

12. The method of claim 5, wherein the step of judging comprises the step of deciding that the motor vehicle is not in the urban environment if a scalar driving style descriptor is above a predetermined descriptor threshold.

13. The method of claim 1, wherein the at least one active subsystem is a suspension system and the at least one operating parameter is a stiffness of the suspension system.

14. The method of claim 1, wherein the at least one active subsystem is a power steering system, and the at least one operating parameter is a degree of assistance provided to a driver.

15. The method of claim 1, wherein the at least one active subsystem is a power steering system, and the at least one operating parameter is a ratio between steering wheel angle and road angle.

16. The method of claim 1, wherein the at least one active subsystem is an engine controller and the at least one operating parameter is a variation of an engine load with an accelerator pedal position.

17. The method of claim 1, wherein the at least one active subsystem is a transmission controller and the at least one operating parameter is an algorithm used for selecting gear ratios.

18. The method of claim 1, wherein the at least one active subsystem is a brake controller, and the at least one operating parameter is a ratio of brake displacement to brake pedal displacement

19. The method of claim 1, wherein the at least one active subsystem is a brake controller, and the at least one operating parameter is an amount of slippage permitted before a system of the brake controller is activated.

20. A suspension controller for a motor vehicle having a chassis and wheels connected to the chassis by a suspension system, a stiffness of which is variable under control of said suspension controller, wherein the suspension controller is adapted to:
repeatedly collecting vehicle motion data;
selecting a setting for at least one operating parameter based on the vehicle motion data;
judging based on the vehicle motion data whether or not the motor vehicle is in an urban environment; and
when selecting said setting, disregarding the vehicle motion data collected while the motor vehicle is judged to be in the urban environment.

21. A computer readable medium embodying a computer program product, said computer program product comprising:
a suspension control program, the suspension control program configured to control a suspension controller for a motor vehicle having a chassis and wheels connected to the chassis by a suspension system, a stiffness of which is variable under the control of said suspension controller, wherein the suspension control program further configured to:
repeatedly collecting vehicle motion data;
selecting a setting for at least one operating parameter based on the vehicle motion data;
judging based on the vehicle motion data whether or not the motor vehicle is in an urban environment; and
when selecting said setting, disregarding the vehicle motion data collected while the motor vehicle is judged to be in the urban environment.
